(19) United States
(12) Patent Application Publication
(10) Pub. No.: US 2014/0306953 A1
(43) Pub. Date: Oct. 16, 2014

(54) 3D Rendering for Training Computer Vision Recognition

(71) Applicants: Pablo Garcia MORATO, Toledo (ES); Frida ISSA, Haifa (IL)

(72) Inventors: Pablo Garcia MORATO, Toledo (ES); Frida ISSA, Haifa (IL)

(21) Appl. No.: 14/140,288

(22) Filed: Dec. 24, 2013

Related U.S. Application Data
(63) Continuation-in-part of application No. 13/969,352, filed on Aug. 16, 2013.

(30) Foreign Application Priority Data
Apr. 14, 2013 (IL) 225756
Apr. 24, 2013 (IL) 225927

(51) Int. Cl. G06T 17/00

(52) U.S. Cl. CPC G06T 17/00
USPC 345/420

(57) ABSTRACT

Rendering systems and methods are provided herein, which generate, from received two-dimensional (2D) object information related to an object and 3D model representations, a textured model of the object. The textured model is placed in training scenes which are used to generate various picture sets of the modeled object in the training scenes. These picture sets are used to train image recognition and object tracking computer systems.

### RELATED APPLICATIONS

This application claims priority to Israel Patent Application No. 225927, filed Apr. 14, 2013, and the contents of which is herein incorporated by reference in its entirety. This application is also related to U.S. application Ser. No. ______, entitled “Visual Positioning System,” by Frida Issa and Pablo Garcia Morato, filed the same date as this application, and U.S. application Ser. No. 13/969,352, entitled “3D Space Content Visualization System,” by Pablo Garcia Morato and Frida Issa, filed Aug. 16, 2013, the contents of both of which are incorporated by reference in their entireties.

### FIELD OF THE INVENTION

The present invention relates to the field of computer vision, and more particularly, to the training of objects in a three-dimensional scene for recognition and tracking

### BACKGROUND

A main challenge in the field of computer vision is to overcome the strong dependence on changing environmental conditions, perspectives, scaling, occlusion and lighting conditions. Commonly used approaches define the object as a collection of features or edges. However, these features or edges depend strongly on the prevailing illumination as the object might look absolutely different if there is more or less light in the scene. Direct light can brighten the whole object, while indirect illumination can light only a part of the object while keeping the rest of it in the shade.

Non-planar objects are particularly sensitive to illumination, as their edges and features change strongly independent of the direction and type of illumination. In particular, current image processing solutions maintain the illumination sensitivity, and moreover cannot handle multiple illumination sources. This problem is a fundamental difficulty of handling two-dimensional (2D) images of three-dimensional (3D) objects. Moreover, the 3D to 2D conversion also makes environment recognition difficult and hence makes the separation between objects and their environment even harder to achieve.

### SUMMARY OF THE INVENTION

One aspect of the present invention provides a rendering system comprising (i) an object three-dimensional (3D) modeler arranged to generate, from received two-dimensional (2D) object information related to an object and at least one 3D model representation, a textured model of the object; (ii) a scene generator arranged to define at least one training scene in which the modeled object is placed; and (iii) a rendering engine arranged to generate from each training scene a plurality of pictures of the modeled object in the training scene.

Another aspect of the present invention provides a rendering method comprising (i) receiving 2D object information related to an object and 3D model representations; (ii) generating a textured model of the object from the 2D object information according to the 3D model representation; (iii) defining at least one training scene which comprises at least one of: variable illumination conditions, variable picturing directions, object and scene textures, at least one object animation and occluding objects; (iv) rendering picture sets of the modeled object in the training scenes; and (v) using the rendered pictures to train a computer vision system, wherein at least one of: the receiving, generating, defining, rendering and using is carried out by at least one computer processor.

Another aspect of the present invention provides a computer-readable storage medium including instructions stored thereon that, when executed by a computer, cause the computer to (i) receive 2D object information related to an object and 3D model representations; (ii) generate a textured model of the object from the 2D object information according to the 3D model representation; (iii) define training scenes which comprise at least one of: variable illumination conditions, variable picturing directions, object and scene textures, at least one object animation and occluding objects; (iv) render picture sets of the modeled object in the training scenes; and (v) use the rendered pictures to train a computer vision system.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a high-level schematic block diagram of a rendering system according to some embodiments of the invention;

FIG. 2 illustrates the modeling and representation stages in the operation of the rendering system according to some embodiments of the invention; and

FIG. 3 is a high-level schematic flowchart of a rendering method according to some embodiments of the invention.

### DETAILED DESCRIPTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

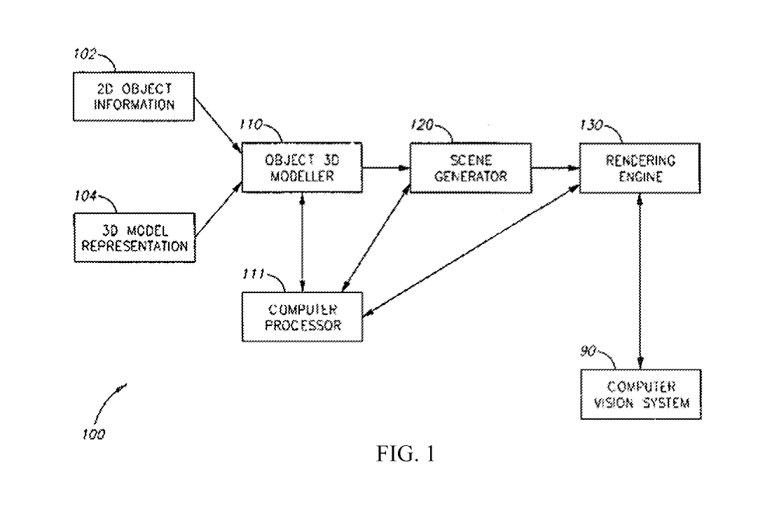

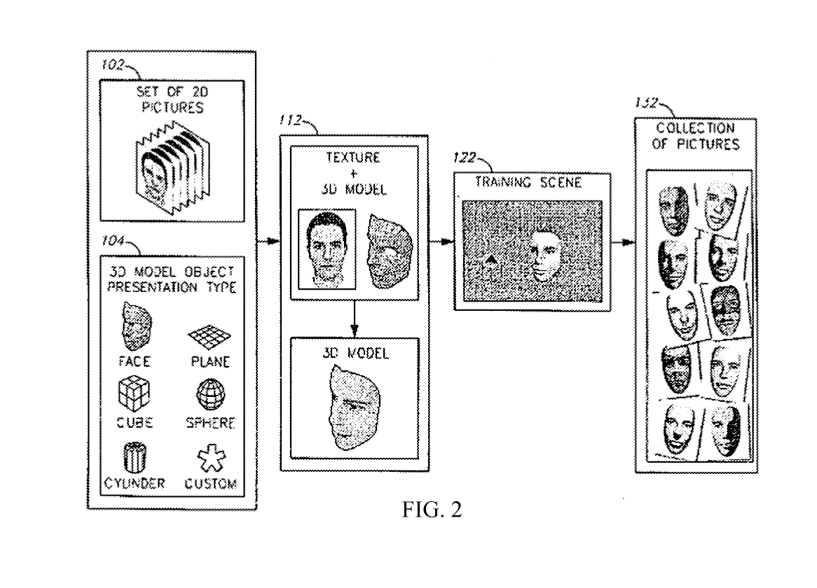

FIG. 1 is a high-level schematic block diagram of a rendering system 100 according to some embodiments of the invention. FIG. 2 illustrates the modeling and representation stages in the operation of rendering system 100 according to some embodiments of the invention.

Rendering system 100 comprises an object three-dimensional (3D) modeler 110 arranged to generate, from received two-dimensional (2D) object information 102 and at least one 3D model representation 104, a textured model 112 of the object. Textured model 112 serves as the representation of the object for training image recognition computer software. Examples for objects which may be defined are faces (as illustrated in FIG. 2), bodies, geometrical figures, various natural and artificial objects, a complex scenario, etc. Complex objects may be modeled using a pre-existing 3D model of them, from an external source. The system can handle typical 3D models like plane, sphere, cube, cylinder, face or any custom 3D model that describes the object to be recognized.

2D information 102 may be pictures of the objects from different angles and perspectives, which enable a 3D rendering of the object. For example, in case of a face, pictures may comprise frontal and side views. Models of surroundings (environment) may comprise various elements in the surrounding such as walls, doors, various objects in the environment, buildings, rooms, corridors or any 3D model. Pictures 102 may further be used to provide specific textures to model 112. The textures may relate to surface characteristics such as color, roughness, directional features, surface irregularities, patterns, etc. The textures may be assigned separately to different parts of model 112.

Rendering system 100 further comprises a scene generator 120 arranged to define at least one training scene 122 in which model 112 is placed. Scene 122 may comprise various surrounding features and objects that constitute the environment of the modeled object as well as illumination patterns, various textures, effects, etc. Scene textures may be assigned separately to different parts of scene 122.

Scenes 122 may comprise objects that occlude object model 112. Occluding objects may have different textures and animations (see below).

Rendering system 100 further comprises a rendering engine 130 arranged to generate from each training scene 122 a plurality of pictures 132 of model 112 in the training scene 122. Picture sets 132 may be used to train a computer vision system 90, e.g., for object recognition and/or tracking. Rendering engine 130 (e.g., using OpenGL or DirectX technology) may apply various illumination patterns and render model 112 in scene 122 from various angles and perspectives to cover a wide variety of environmental effects on model 112. These serve as simulations of real-life effects of the surroundings to be trained by the image processing system. Rendering engine 130 comprises rendering a “camera movement” while rendering model 112 in scene 122 to generate picture sets 132. The rendered camera movement may approach and depart from model 112 and move and rotate with respect to any axis. Camera movements may be used to render animation of the object and or its surroundings.

Animations may comprise effects relating to various aspects of model 112 and scene 122 (e.g. visibility, rotation, translation, scaling and occlusion). For example, the texture of the model 112 may vary with changing illumination and perspective, shadows may create a variety of resulting pictures 132 (see FIG. 2) and animation may be added to model 112 to simulate movements. The resulting picture sets hence include effects of various “real-life” situation factors. System 100 is configured to allow associating animations with any object in scene 122 and hence creating a scene that covers any possible situation in the real scene. Picture sets 132 may be taken as (2D) snapshots during the advancement of the animation. Hence, pictures 132 incorporate all illumination, texture and perspective effects and thus serve as realistic modeling of the object in the scene.

3D modeler 110 may be further arranged to model object features and add the modeled object features to the 3D model representation. For example, in case of a face model the system may offer training for the effect of an additional typical face reality combination of illumination, translation, scaling or rotation animation, for example an object-typical feature, e.g., objects that hide the face like glasses and hair or beard. 3D modeler 110 may apply the feature to any face to create such training effects, for example recognition in spite of hair cut changes, beard appearing or disappearing from the face, glasses display and removal. 3D modeler 110 may also apply different facial expressions as the object features and train for changing facial expressions.

In embodiments, animation added may comprise zooming in and out, rotating model 112 on any axis, or rotating the light objects, defining a path of the camera to move through object model 112 and/or through scene 122, etc. Animations may be particularly useful in training computer vision system 90 to track objects, as the animations may be used to simulate many possible motions of the objects in the scene.

In embodiments, at least one of object 3D modeler 110, scene generator 120 and rendering engine 130 is at least partially implemented by at least one computer processor 111. For example, system 100 may be implemented over a computer with GPU (graphics processing unit) capabilities.

In embodiments, the added animation may comprise at least one motion animation of a specified movement that is typical to the object, and rendering engine 130 may be arranged to apply the at least one motion animation to the modeled object. For example, typical facial gestures such as smiling or winking, or typical motions such as gait, jumping, etc. may be applied to the rendered object. Such motion animations may be object-typical, and extend beyond not simple translation, rotation or scaling animation.

Advantageously, embodiments of the invention connect the original sample object with the reality conditions automatically. The system relies on 3D rendering techniques to create more accurate and more realistic representations of the object.

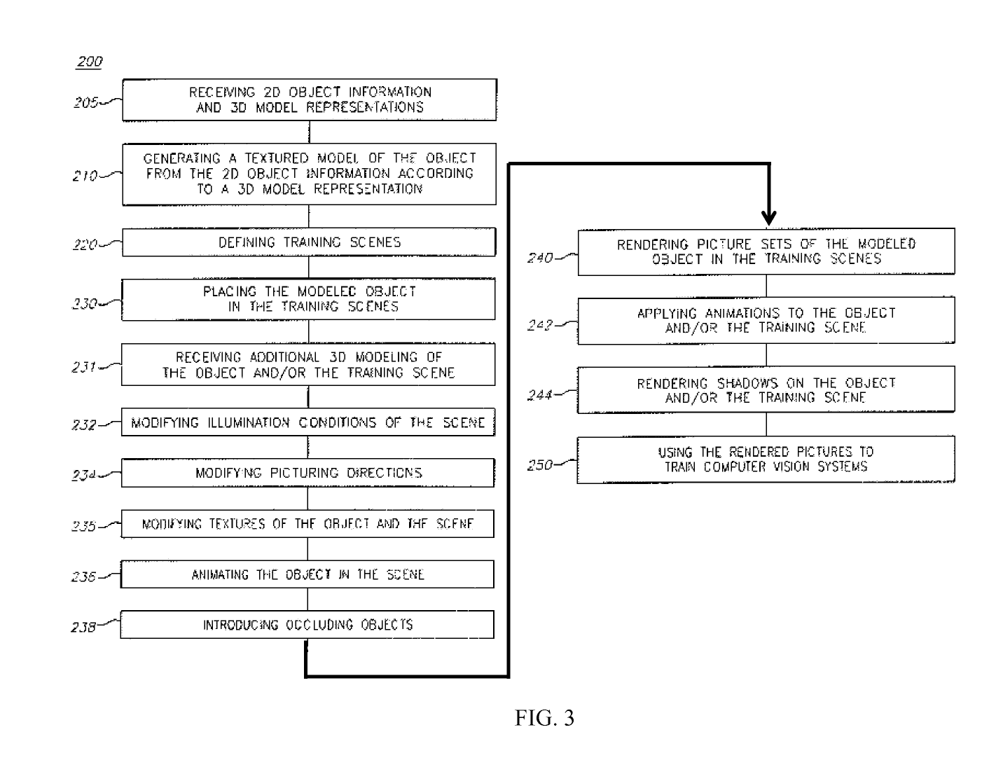

FIG. 3 is a high-level schematic flowchart of a rendering method 200 according to some embodiments of the invention. Any step of rendering method 200 may be carried out by at least one computer processor. In embodiments, any part of method 200 may be implemented by a computer program product comprising a computer readable storage medium having a computer readable program embodied therewith, and implementing any of the following stages of method 200. The computer program product may further comprise a computer readable program configured to interface computer vision system 90.

Method 200 may comprise the following stages: receiving 2D object information related to an object and 3D model representations (stage 205); generating a textured model of the object from the 2D object information according to the 3D model representation (stage 210); defining training scenes (stage 220) which comprise at least one of: variable illumination conditions, variable picturing directions, object and scene textures, at least one object animation and occluding objects; rendering picture sets of the modeled object in the training scenes (stage 240); and using the rendered pictures to train a computer vision system (stage 250).

The picture sets may be rendered (stage 240) by placing the modeled object in the training scenes (stage 230) and possibly carrying out any of the following stages: modifying illumination conditions of the scene (stage 232); modifying picturing directions (stage 234); modifying textures of the object and the scene (stage 235); animating the object in the scene (stage 236) and introducing occluding objects (stage 238).

In embodiments, training scene 122 comprises an illumination scenario which may comprise various light sources. The variable illumination may comprise ambient lighting (a fixed-intensity and fixed-color light source that affects all objects in the scene equally), directional lighting (equal illumination from a given direction), point lighting (illumination originating from a single point and spreading outward in all directions), spotlight lighting (originating from a single point and spreading outward in a coned direction, growing wider in area and weaker in influence as the distance from the object grows), area lighting (originating from a single plane), etc. Particular attention is given to shadowing and reflection effects caused by different illumination patterns with respect to different textures of model 112 and scene 122.

Method 200 may further comprise receiving additional 3D modeling of the object and/or of the training scene (stage 231). In embodiments the additional 3D modeling may comprise object features that may be rendered upon or in relation to the object to illustrate collision between objects that might affect the recognition of the original object.

Method 200 may further comprise applying animation(s) to the modeled object and/or to the training scene (stage 242), which may include a simulated camera movement, a zoom in or out, a rotation, a translation, a light source movement, a visibility change, a motion animation of a movement that is typical to the object, etc.

Method 200 may further comprise rendering shadows on the textured object and/or on the training scene (stage 244).

In the above description, an embodiment is an example or implementation of the invention. The various appearances of “one embodiment,” “an embodiment,” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Embodiments of the invention may include features from different embodiments disclosed above, and embodiments may incorporate elements from other embodiments disclosed above. The disclosure of elements of the invention in the context of a specific embodiment is not to be taken as limiting their use in the specific embodiment alone.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A rendering system comprising:
an object three-dimensional (3D) modeler arranged to generate, from a received two-dimensional (2D) object information related to an object and at least one 3D model representation, a textured model of the object;
a scene generator arranged to define at least one training scene in which the modeled object is placed; and
a rendering engine arranged to generate from each training scene a plurality of pictures of the modeled object in the training scene,
wherein at least one of the object 3D modeler, the scene generator and the rendering engine is at least partially implemented by at least one computer processor.

2. The rendering system of claim 1, wherein the textured model comprises surface characteristics.

3. The rendering system of claim 1, wherein the 3D modeler is further arranged to receive additional 3D modeling of the object.

4. The rendering system of claim 1, wherein the 3D modeler is further arranged to model object features and add the modeled object features to the 3D model representation.

5. The rendering system of claim 1, wherein the scene generator is further arranged to receive additional 3D modeling of the scene.

6. The rendering system of claim 1, wherein the at least one training scene comprises an illumination scenario.

7. The rendering system of claim 1, wherein the at least one training scene comprises at least one occluding object with respect to the object model.

8. The rendering system of claim 1, wherein the rendering engine is further arranged to apply at least one animation to at least one of the modeled object and the at least one training scene.

9. The rendering system of claim 8, wherein the at least one animation comprises at least one of: a simulated camera movement, a zoom in or out, a rotation, a translation, a light source movement, and a visibility change.

10. The rendering system of claim 8, wherein the at least one animation comprises at least one motion animation of a specified movement that is typical to the object, and the rendering engine is arranged to apply the at least one motion animation to the modeled object.

11. The rendering system of claim 1, wherein the rendering engine is further arranged to render shadows on the textured object and the at least one training scene.

12. A rendering method comprising:
receiving 2D object information related to an object and 3D model representations;
generating a textured model of the object from the 2D object information according to the 3D model representation;
defining at least one training scene which comprises at least one of: variable illumination conditions, variable picturing directions, object and scene textures, at least one object animation and occluding objects;
rendering picture sets of the modeled object in the training scenes; and
using the rendered pictures to train a computer vision system,
wherein at least one of: the receiving, generating, defining, rendering and using is carried out by at least one computer processor.

13. The rendering method of claim 12, further comprising receiving additional 3D modeling of at least one of: the object, object features and the at least one training scene.

14. The rendering method of claim 12, further comprising applying at least one animation to at least one of the modeled object and the at least one training scene, the at least one animation comprising at least one of: a simulated camera movement, a zoom in or out, a rotation, a translation, a light source movement, a visibility change and a motion animation of a movement that is typical to the object.

15. The rendering method of claim 12, further comprising rendering shadows on the textured object and the at least one training scene.

16. A non-transitory computer-readable storage medium including instructions stored thereon that, when executed by a computer, cause the computer to:
receive 2D object information related to an object and 3D model representations;
generate a textured model of the object from the 2D object information according to the 3D model representation;
define training scenes which comprise at least one of: variable illumination conditions, variable picturing directions, object and scene textures, at least one object animation and occluding objects;
render picture sets of the modeled object in the training scenes; and
use the rendered pictures to train a computer vision system.

17. The computer-readable storage medium of claim 16, wherein the instructions are further configured to cause the computer to interface with the computer vision system.

18. The computer-readable storage medium of claim 16, wherein the instructions are further configured to cause the computer to receive additional 3D modeling of at least one of: the object, object features and the at least one training scene.

19. The computer-readable storage medium of claim 16, wherein the instructions are further configured to cause the computer to apply at least one animation to at least one of the modeled object and the at least one training scene, the at least one animation comprising at least one of: a simulated camera movement, a zoom in or out, a rotation, a translation, a light source movement, a visibility change, and a motion animation of a movement that is typical to the object.

20. The computer-readable storage medium of claim 16, wherein the instructions are further configured to cause the computer to render shadows on the textured object and the at least one training scene.
